(19) United States
(12) Patent Application Publication
(10) Pub. No.: US 2007/0217401 A1
(43) Pub. Date: Sep. 20, 2007

(54) Video-and-audio transmission method for VoIP phone

(75) Inventor: Hsi Huang, Taipei (TW)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/657,630

(22) Filed: Jan. 25, 2007

(30) Foreign Application Priority Data
Mar. 14, 2006 (TW) 95108610

(51) Int. Cl. H04L 12/66

(52) U.S. Cl. 370/356

(57) ABSTRACT

A video-and-audio transmission method is provided for a VoIP (Voice over Internet Protocol) phone. The VoIP phone is communicated with a server. The video-and-audio transmission method includes the steps: (a) the VoIP phone releasing a video-and-audio data upon receipt thereof; (b) judging whether the VoIP phone has received an activating command or not; (c) if yes, sending a request for a detailed list of the video-and-audio data to the server; (d) the server searching a built-in database for a specific detailed list according to the detailed list; (e) transmitting the specific detailed list to the VoIP phone; and (f) the VoIP system releasing the specific detailed list upon receipt thereof. The server is capable of compiling a statistic of user selection based on the request for the detailed list.

### FIELD OF THE INVENTION

The invention relates to a video-and-audio transmission method, and more particularly to an interactive type video-and-audio transmission method for use in a VoIP (Voice over Internet Protocol) phone.

### BACKGROUND OF THE INVENTION

Each family of present day may have at least one PC (Personal Computer) at home. The PC is mostly connected to the Internet since the Internet Service Providers offer lower and lower network charges day by day. Therefore more and more households have their PCs connected to the Internet via the broadband network. With the Internet and using broadband network services, one can send e-mails, message, music and video to his friends, exchange talks or can conduct even video conference. The traditional communicating way (such as letters delivery and phone conversation) among friends and business establishments is gradually replaced by the Internet Services.

Currently, there are several hot network services available in the market. There are some software or programs, such as VoIP software, Skype and MSN, which enable people to communicate one another over the Internet rather than the plain old telephone system (POTS). Both parties wishing to communicate over the Internet must have the PCs connected to the Internet, and must download VoIP software or register the caller IP addresses at the Internet Service Provider. Some transmitting and receiving equipments, like microphone, headset, speaker, the IP phone and the corresponding software must also be installed in the PC. After these arrangements, both parties can communicate with each other over the Internet without charges (even bypassing the telephone company) or at a very low charge. Though, the aforementioned VoIP technology is much appreciated by business establishments and the consumers, there arise some problems when the VoIP network is utilized.

In case, the VoIP network provides only the interactive audio service and is therefore inefficient in view of economics when using broadband for transmission. Therefore, it is the object of the present invention to provide an interactive type video-and-audio transmission method for use in the VoIP system, thereby gradually leading to the multi-purpose functions.

Moreover, since the VoIP system is capable of releasing the video-and-audio data, the advertising firms utilizes the VoIP system in addition to the flat media or the TV set in order to enhance the advertising ability thereof. Presently, most advertisements are dispatched in a one-way direction, i.e. no public response or consumer's opinion can be collected once the advertisement goes over the TV. The market survey is usually conducted after distribution of the leaflets or DM.

### SUMMARY OF THE INVENTION

The object of the present invention is to provide an interactive type video-and-audio transmission method for use in a VoIP (Voice over Internet Protocol) phone such that in case the watcher or consumer of the VoIP phone is interested in the video-and-audio data, a follow up service can be forwarded to him. A statistic of the consumers' response or selection can be compiled based on the follow up services at the server end.

According to the present invention, an interactive type video-and-audio transmission method is provided for a VoIP (Voice over Internet Protocol) phone. The VoIP phone is communicated with a server. The video-and-audio transmission method includes the steps: (a) the VoIP phone releasing a video-and-audio data upon receipt thereof; (b) judging whether the VoIP phone has received an activating command or not; (c) if yes, sending a request for a detailed list of the video-and-audio data to the server; (d) the server searching a built-in database for a specific detailed list according to the detailed list; (e) transmitting the specific detailed list to the VoIP phone; and (f the VoIP phone releasing the specific detailed list upon receipt thereof. The server is capable of compiling a statistic of user selection based on the request for the detailed list.

### BRIEF DESCRIPTION OF THE DRAWING

Other features and advantages of this invention will become more apparent in the following detailed description of the preferred embodiment of this invention, with reference to the accompanying drawings, in which:

FIG. 1 illustrates how a VoIP phone is connected to a server according to the present invention; and

FIG. 2 is a flow chart illustrating the steps of the video-and-audio transmission method of the present invention for use in the VoIP phone.

### DETAILED DESCRIPTIONS OF THE PREFERRED EMBODIMENT

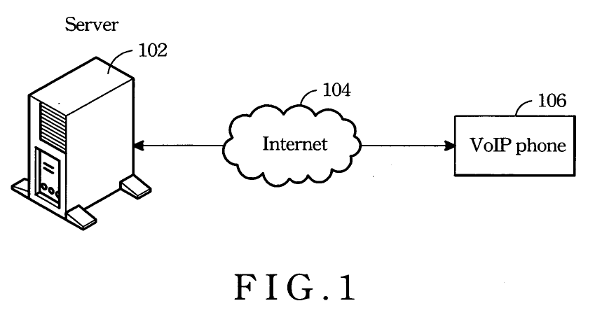

FIG. 1 is the structure embodiment illustrating how the VoIP phone 106 is communicated with a server 102 via the Internet 104 according to the present invention.

In this embodiment, the VoIP phone 106 can be connected to the server 102 over the Internet 104 wirelessly or via the cable network.

The server 102 is installed at the network service provider of the VoIP phone 106. The IP address of the server 102 is burned into the VoIP phone 106.

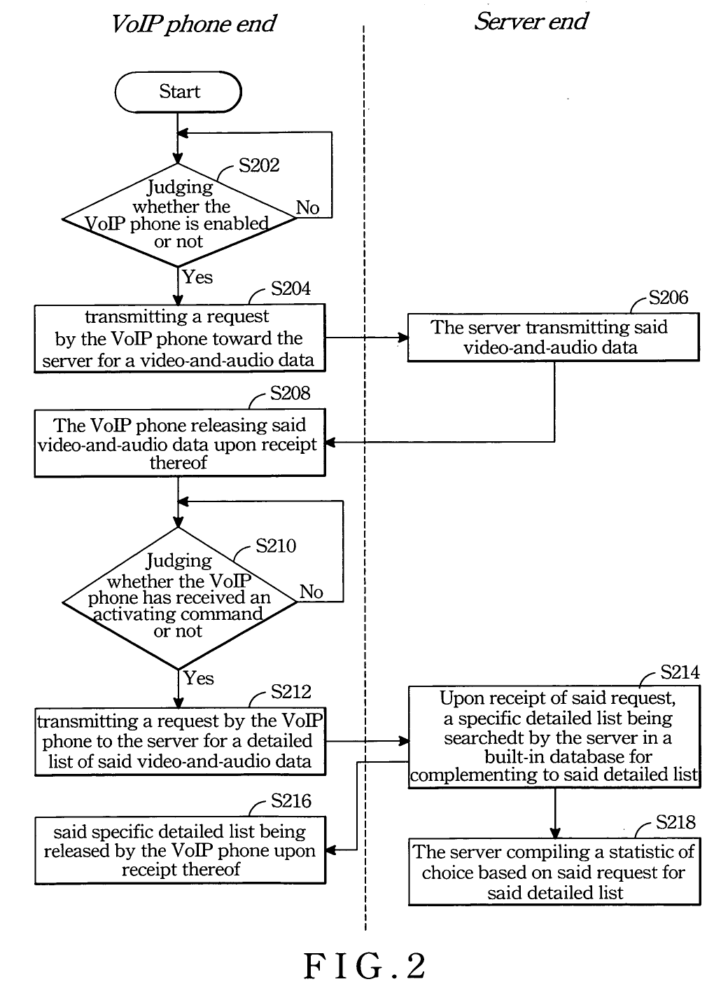

FIG. 2 shows a flow chart illustrating the steps of the video-and-audio transmission method used in the VoIP phone of the present invention. In this embodiment, the server 102 outputs a video-and-audio data to the VoIP phone 106 via the Internet 104. In the step (S208), the VoIP phone 106 releases the video-and-audio data and provides a list for the user to make a selection.

The VoIP phone 106 includes an LCD (liquid crystal display) module and a speaker (not shown) so that the video image is displayed on the LCD while the audio data is released over the speaker.

During the release of the video-and-audio data, the VoIP phone 106 constantly judges whether it has received an activating command or not (S210). Touching the LCD module or the button key of the VoIP phone 106 when the user selects an item in the selection list can generate the activating command.

Upon receipt of the activating command, the VoIP phone 106 sends a request to the server 102 over the Internet 104 for a detailed list of the video-and-audio data (S 212). Upon receipt of the request, the server 102 searches a built-in database for a specific detailed list according to the detailed list (S214).

In this embodiment, after the step (S214), the server 102 transmits the specific detailed list to the VoIP phone 106 over the Internet 104 (S216). Finally, the VoIP phone 106 displays and releases the specific detailed list with the assistance of the LCD module and the speaker (S218).

During designing the VoIP phone 106, it can be designed in such a manner that the phone 106 is enabled to display and release the video-and-audio data during the operation or when the phone 106 is not operated. The design of the VoIP phone 106 depends on the user's requirements at the user end. No restriction should be applied to the designing of the VoIP phone 106.

In the present embodiment, the server 102 can compile a statistic of user selection based on the request of the detailed list such that a file containing the likes and dislikes of the consumers (VOIP phone users) can be obtained for record. The file may play an important reference for business promotion.

In case it is designed to released or display the video-and-audio data during use of the VoIP phone 106, the latter constantly judges whether it is enabled or not once the phone communicates with the Internet 104 (S202).

Upon judging that the VoIP phone 106 is enabled, a request is outputted by the VoIP phone 106 to the server 102 over the Internet 104 for receiving the video-and-audio data (S204) prior to the release of the video-and-audio data. In case, judging that the VoIP phone 106 is disabled, the transmission step returns to the step (S202).

In this embodiment, the server 102 transmits, upon receipt of a request, the video-and-audio data to the VoIP phone complementing with the request (S206).

In the present invention, the video-and-audio data may be a commercial advertisement including a plurality of classified announcements. The specific detailed list defines the plurality of the classified announcements. When the user end encounters some problems with the advertisement, such as he wishes to see or have the detailed list (or content) of the commercial advertisement, the user end can directly make communication with the advertisement firm over the VoIP phone 106.

In one preferred embodiment, the VoIP phone 106 offers a variety of choices during release of the video-and-audio data. Each choice represents an activating command. The activating command is generated when the user makes a choice from the video-and-audio data. The VoIP phone 106 outputs a request for a detailed list of the video-and-audio data. The server 102 in response outputs a specific detailed list to the VoIP phone 106. By collecting several different or same requests, the server 102 can compile a statistic recording the selections of the consumers. The video-and-audio data can be a program list having a plurality of optional programs for selection. In the same manner, the optional programs define the specific detailed list.

In another preferred embodiment, the network service provider of the VoIP phone 106 can form the user of the VoIP phone 106 the consumer satisfaction extent based on the market survey utilizing the aforementioned recorded statistic.

The following advantages can be achieved when the video-and-audio transmission method of interactive type is used.

(1)The video-and-audio data can be transmitted to the VoIP phone. When the user has an interest in the video-and-audio data, a specific detailed list can be forwarded to the user in the interactive manner.

(2) The user can fully control the decision-making scheme since he can ask question prior to making the final decision.

(3) With this interactive type transmission method, the user can receive the network data without the assistance of the computer since the server actively transmits the data to the VoIP phone;

(4) The user can access his personal data, such as banking accounts and electronic mails at any given time if he wants to.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An interactive type video-and-audio transmission method for a VoIP (Voice over Internet Protocol) phone, the VoIP phone communicating with a server, the video-and-audio transmission method comprising:
(a) the VoIP phone releasing a video-and-audio data upon receipt thereof;
(b) judging whether the VoIP phone receives an activating command or not;
(c) if yes, sending a request for a detailed list of said video-and-audio data to the server;
(d) the server searching a built-in database for a specific detailed list according to said detailed list;
(e) transmitting said specific detailed list to the VoIP phone; and
(f) the VoIP phone releasing said specific detailed list upon receipt thereof;
wherein, the server is capable of compiling a statistic of user selection based on said request for said detailed list.

2. The video-and-audio transmission method according to claim 1, wherein said video-and-audio data comprises a commercial advertisement.

3. The video-and-audio transmission method according to claim 2, wherein said commercial advertisement comprises a plurality of classified announcements, said specific detailed list defining said classified announcements.

4. The video-and-audio transmission method according to claim 1, wherein said video-and-audio data comprises a program list including a plurality of optional programs for selection.

5. The video-and-audio transmission method according to claim 4, wherein said plurality of optional programs defines said specific detailed list.

6. The video-and-audio transmission method according to claim 1, wherein the VoIP phone communicates with the server via the Internet.

7. The video-and-audio transmission method according to claim 6, wherein the VoIP phone communicates with the Internet wirelessly.

8. The video-and-audio transmission method according to claim 6, wherein the VoIP phone communicates with the Internet via a cable network.

9. The video-and-audio transmission method according to claim 1, the server is installed at a network service provider.

10. The video-and-audio transmission method according to claim 1, further comprising:
(g) judging whether the VoIP phone being enabled or not prior to the step (a);
(h) if yes, sending a request for said video-and-audio data to the server; and
(i) the server transmitting said video-and-audio data to the VoIP phone for releasing said video-and-audio data.
